(19) United States
(12) Patent Application Publication
(10) Pub. No.: US 2006/0287964 A1
(43) Pub. Date: Dec. 21, 2006

(54) Contact/contactless and magnetic-stripe data collaboration in a payment card

(76) Inventor: Kerry D. Brown, Portola Valley, CA (US)

Correspondence Address: PATENTS PENDING, 9832 LOIS STILTNER CT, ELK GROVE, CA, 95624, US

(21) Appl. No.: 11/502,772

(22) Filed: Aug. 14, 2006

Related U.S. Application Data
(63) Continuation-in-part of application No. 11/478,758, filed on Jun. 29, 2006.
Application No. 11/478,758 is a continuation-in-part of application No. 11/404,660, filed on Apr. 14, 2006.
Application No. 11/404,660 is a continuation-in-part of application No. 10/738,376, filed on Dec. 17, 2003, now Pat. No. 7,044,394.

(51) Int. Cl. G06Q 99/00

(52) U.S. Cl. 705/64

(57) ABSTRACT

A method of providing a magnetic-stripe type payment card with coupons and micropayment authorizations provides an internal link on a payment card between a contact/contactless processor and a MEMS magnetic device. This communicates information received from a contact/contactless payments infrastructure to be presented to a magnetic stripe payments infrastructure as specially recorded data bits written by the MEMS magnetic device in a magnetic stripe track.

### RELATED APPLICATIONS

This application is a continuation-in-part of U.S. patent application Ser. No. 11/478,758, filed Jun. 29, 2006, titled QCHIP MEMS MAGNETIC DEVICE; which is a continuation-in-part of U.S. patent application Ser. No. 11/404,660, filed Apr. 14, 2006, titled AUTOMATED PAYMENT CARD FRAUD DETECTION AND LOCATION; which was, in turn, a continuation-in-part of now issued U.S. Pat. No. 7,044,394 B2, issued May 16, 2006. These are incorporated herein by reference.

### BACKGROUND OF THE INVENTION

1. Field of the Invention

The present invention relates to payment systems, and more particularly to Payment cards and methods for bridging the payment, contact/contactless and contactless and magnetic stripe technology infrastructures that support consumer payments, authentication, incentives, and loyalty programs.

2. Description of Related Art

Payment cards have evolved from simple plastic blanks with embossed numbers that could be imprinted on paper drafts with carbon papers, to those including magnetic stripes that can be read electronically by a vending machine without a clerk. These payment cards further evolved into smart cards with contacts, and then contact/contactless interfaces, that use computer encryption technology to secure the card, its user, merchants, payment processors, and the issuing banks against fraud. The worldwide infrastructure supporting magnetic stripe payment cards is so well-understood, functional, ubiquitous, and entrenched, that the deployment of “newer” and “better” technologies like contact/contactless smart cards has to remain compatible with this infrastructure to minimize merchant resistance.

Herein, “contact” and “contactless” smart-card technologies include cryptoprocessor and smartchips capable of wired and wireless transactions typically based upon French Banking standard known as “B0′” (B-zero-prime), Europay-MasterCard-Visa (EMV) industry specifications ISO 14443 (a) (b), Near Field Communication (NFC), infra-red, ultra-wideband (UWB), Bluetooth, Zigbee, B0′, and similar protocols associated with these “smart” microcontrollers.

The contact/contactless smart card technology is very effective in reducing the costs of fraud. Merchant fees for magnetic stripe cards are being reduced from 2-3% down to 1% for contact/contactless smart cards and micropayment authorizations because the issuing banks losses are so much better controlled.

The traditional minimum credit card transaction widely understood by the public is usually about $10, under a certain amount negotiated with the merchant associated with the transaction, and the issuer and association. Small value transactions result in lower merchant profit margin due to the high transaction fees formerly associated with these micropayments, hence the introduction of lower transaction fees and new business models for micropayments. So-called “micropayments” for transactions are now finding favor with vending machines, public transportation, public phones, parking meters, and low price merchant products, etc. Contact/contactless technology has been on the front wave enabling more and more micropayment transactions due to the greater security inherent in the EMV/Contact/Contact/contactless security features of these cards. But micropayments with magnetic stripe credit cards has been unknown, due to the security factor associated with a static data magnetic stripe.

The present inventor, Kerry D. Brown, describes these concepts and the history more thoroughly with his co-inventors in United States Patent Application Publication US 2004/0029569 A1, published Feb. 12, 2004, titled MICROPAYMENT FINANCIAL TRANSACTION PROCESS UTILIZING WIRELESS NETWORK PROCESSING.

Cellphones can be used to host payment software in support of wireless payment transactions. The present inventor, Kerry D. Brown, describes such technologies with his co-inventors in United States Patent Application Publication US 2006/0000900 A1, published Jan. 5, 2006, titled COLLABORATIVE NEGOTIATION TECHNIQUES FOR MOBILE PERSONAL TRUSTED DEVICE FINANCIAL TRANSACTIONS. Consumers can carry several aggregated payment cards in their “wallets”, and merchants will accept some of these. A transaction is automatically matched that suits both their preferences.

Microprocessor cards based on the Europay-Mastercard-Visa (EMV) international standard defined by MasterCard and Visa are gradually replacing magnetic stripe cards. Oberthur Card Systems (Rancho Dominguez, Calif.) says the migration of credit cards to the EMV standard in the banking sector is a major challenge. They offer cards that still retain the magnetic stripes, e.g., for the USA market. But these carry purely static magnetic recordings.

The primary objectives of both the contact/contactless and contact/contactless cards with microprocessors are to reduce fraud and promote new services. For cardholders, wider card acceptance, both in brick-and-mortar locations and on the Internet, and increased point of sale security. For banks, the payment card has come to represent the preferred means of acquiring new customers and retaining existing customers by offering ever more innovative and original services.

What is needed is a payment card that can interface with both the existing contact/contact/contactless and magnetic-stripe electronic payment infrastructures, and then share data between both within the card. What is also needed is a payment infrastructure that can use its contact/contactless systems to improve magnetic-stripe transactions, and that allows magnetic-stripe transactions to provide useful data for the contact/contactless systems.

### SUMMARY OF THE INVENTION

Briefly, a payment card embodiment of the present invention comprises a contact/contactless interface smart card processor, and a QChip™ MEMS magnetic device embedded in part of a magnetic stripe. The QChip MEMS magnetic device generates new sub-sets of magnetic data that are written in combination with other permanently recorded magnetic data in the surrounding surface of the magnetic stripe. A swipe sensor senses swipes with a legacy magnetic stripe card reader, and a transaction event count can be provided to the contact/contactless smart card processor, for example, to accumulate loyalty program points.

An advantage of the present invention is that a payment card is provided that is compatible with both the existing magnetic-stripe type legacy payment card systems and infrastructure, and the newer contact/contactless smart card systems and infrastructure.

A further advantage of the present invention is that a payment card is provided that can receive preauthorizations for making micropayments with magnetic-stripe type legacy payment card systems and infrastructure.

Another advantage of the present invention is a payment card is provided that can reduce losses due to fraud.

A still further advantage of the present invention is that a loyalty system is provided in which coupons can even be communicated to merchant terminals that support only magnetic stripe readings.

A further advantage of the present invention is that a card is provided that can count transactions and enable issuer-based loyalty and promotion programs which can be transferred to other magnetic stripe terminals.

An additional advantage of the present invention is a card is provided that can communicate its power and functional status to the issuer and transaction network.

An additional advantage of the present invention is a card is provided that can communicate magnetic stripe based transactions to the contact/contactless network.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a functional block diagram of a payment card system embodiment of the present invention;

FIG. 2 is a perspective diagram of a payment card embodiment of the present invention;

FIG. 3 is a functional block diagram of a payment system embodiment of the present invention in which coupons can be passed from the contact/contactless infrastructure to the magnetic stripe infrastructure and vice versa, and from the magnetic stripe infrastructure to the magnetic stripe infrastructure, through the payment card;

FIG. 4 is a functional block diagram of a micropayments system embodiment of the present invention in which coupons can be passed from the contact/contactless infrastructure to the magnetic stripe infrastructure through the payment card; and

FIG. 5 is a functional block diagram of a loyal program system embodiment of the present invention in which transaction can be passed from the magnetic-stripe infrastructure to the contact/contactless infrastructure through the payment card.

### DETAILED DESCRIPTION OF THE INVENTION

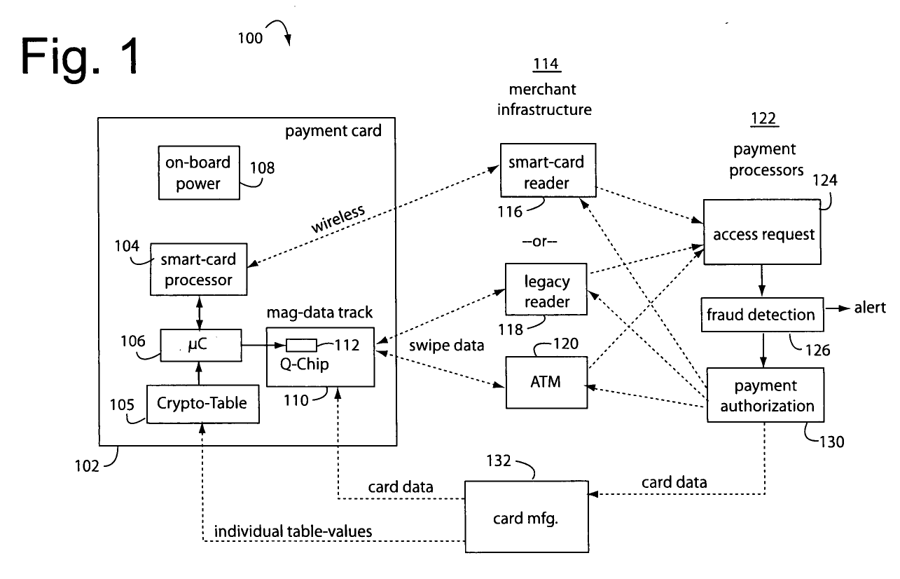

FIG. 1 illustrates a payment card system embodiment of the present invention, and is referred to herein by the general reference numeral 100. System 100 comprises a payment card 102 in a credit-card format, an industry-standard contact/contactless smart-card processor 104, a crypto-table or run-time cryptographic algorithm 105, a “QChip” microcontroller 106 to access the crypto-table or run a cryptographic algorithm, a battery 108, and a magnetic data track 110 that includes a magnetic QChip MEMS device with integrated swipe sensor, or off-chip swipe sensor 112. Such Microcontroller (μC) 106 and QChip MEMS device 112 are described more completely in U.S. patent application Ser. No. 11/478,758, filed Jun. 29, 2006, titled QCHIP MEMS MAGNETIC DEVICE; U.S. patent application Ser. No. 11/404,660, filed Apr. 14, 2006, titled AUTOMATED PAYMENT CARD FRAUD DETECTION AND LOCATION; and U.S. Pat. No. 7,044,394 B2, issued May 16, 2006. The whole of the magnetic data in track 110 is partially affected by the Microcontroller (μC) 106 through QChip MEMS device 112 according to crypto-table or locally derived values.

A present-day point-of-sale community is represented by a merchant infrastructure 114, in that a mixture of contact/contactless smart-card readers 116, and magnetic readers 118 and ATM's 120 can be encountered by consumers using payment card 102. These communicate transaction information and payment requests to a payment processor 122 to authenticate the user account and approve the transaction. These may include coupon, incentives, or loyalty program indicia that can qualify the user for discounts and other rewards. If appropriate, the rewards are communicated back through contact/contactless processor 104 and ultimately to QCHIP MEMS DEVICE 112. A magnetic bit flag may be set in track 110 to indicate the payment card 102 is authorized for micropayments, can redeem a coupon, etc. Additionally, the QChip can relay such basic information as power status, functionality, and number of swipe transactions to the contact/contactless processor 104 for communication to the contact/contact/contactless infrastructure.

Payment processor 122 includes an account access request process 124, a fraud detection process 126, and a payment authorization process 130. These may also be used to administer loyalty program and inter-partner data exchanges, especially when program data must be bridged bi-directionally between the magnetic payment infrastructure and contact/contactless smart-card payment infrastructure via payment card 102. Herein, the magnetic payment infrastructure is represented by all the legacy readers 118 and ATM's 120, and their supporting payment processors 122 deployed in the world. The contact/contactless smart-card payment infrastructure is represented by all the smart-card readers 116 and their supporting payment processors 122 deployed around the world.

The dimensions, materials, magnetics, recordings, and data formats used by card 102 are dictated by industry “ISO standards” for bank payment cards and specifications for contact/contactless smart-card standards reference similar industry ISO Standards, including, but not limited to, ISO 7810, 7816 use. (See, www.emvco.com for the specific relating to the EMV standards.) The several components described herein all must fit within these constraints. The merchant infrastructure 114 and payment server 122 represented in FIG. 1 are typical, many other variations exist but still can benefit from embodiments of the present invention.

In a micropayment enabled magnetic stripe (MEMS2) embodiment, a micropayment is authorized for a small mount without showing ID or signature, e.g., for American Express this is limited to $100, and for Visa and MasterCard it's limited to $25. In the prior art, such is only available in the USA using contact/contactless technology, although contact/contactless technology is being implemented in Europe, possibly displacing the more prevalent contact-EMV technology implemented during the past decade. A contact/contactless authorization is loaded here and is tracked by a status bit in the magnetic data track 110 to enable a magnetic stripe micropayment. Supporting software is required to be installed in preexisting merchant structure 114 and/or the payment processor 122.

Magnetic data track 110 provides intelligence and feedback. The MEMS coil array can be used as a receiver during a personalization process to load data through inductive coupling. Card swipe sensors integrated on the top surface of the MEMS device are used to count transactions, not swipes. A single transaction may require a few swipes to get the card properly read such as if the reader is dirty or defective.

A promoter could advertise that after a hundred uses of their card, the user will be entered into a sweepstakes contest, or has earned a free cup of coffee, etc. The swipe data can be uploaded, via the Microcontroller (μC) 106, back up to the contact/contactless processor 104, enabling a contact/contactless coupon exchanged from the magnetic data track 110.

The magnetic data track 110 can be used to store a battery status. When Microcontroller (μC) 106 senses low battery condition, it writes a unique code into the discretionary field after the issuer-defined transaction window of approximately 5 minutes. Alternatively, this field can be rewritten after five minutes with a new code, e.g., in case of component failure or low battery where there isn't enough power or ability to write a next result. The issuing bank, or other entity in the transaction loop, reads the code, and sends out a new replacement card when appropriate. During such dead battery time, the banks may chose to nevertheless approve transactions as they normally do with card with a completely static magnetic data track, if the fraud/coupon component gets stopped.

The magnetic data track 110 can communicate with the contact/contactless chip, and to other magnetic data track terminals, enabling information sharing that ranges from card swipe counting to bi-directional contact/contactless coupon sharing. The ISO 7810/7816 specifications and ABA/IATA stripe data fields describe a “discretionary field”, and “other data field” that can be used exclusively for the issuing bank. These can be used to place operators, which can be as simple as a single status bit.

The variable data field uses include fraud control, points of original compromise identification, multiple cards selection, multiple accounts selection, coupon programs, loyalty and branding programs, power monitoring, etc.

The Microcontroller (μC) 106 is able to communicate at least three different levels of status to the mag stripe and/or contact/contactless. If the QChip 112 itself is physically broken, then the magnetic domain gaps will be incorrect, or the magnetic domains will be scattered, resulting in a parity error at the merchant point-of-sale (POS). If the Microcontroller (μC) 106 always writes a special code to the QChip 112 after every five minute (issuer defined) window, such as “00000”, then a dead battery, faulty microprocessor, or other interconnect problem, will result in this code being transmitted with the next transaction. If the Microcontroller (μC) 106 and related circuitry is operational, then a new code will be generated with each POS swipe, assuming it is past the issuer-defined window. So, dysfunctional circuitry will result in a special code being transmitted through the financial transaction network. It is up the bank rules-based-system to determine what action should be taken e.g. pass the transaction, much like a regular card, and send out a new card, etc. A field of all zeroes does not need to be written, a number that would never occur from the crypto-table 105, e.g., an exception number can be placed to signal the error. If the Microcontroller (μC) 106 data appears static, then the card being used is probably a skimmed copy and easy to spot. It's possible it may be a dysfunctional card with a Microcontroller (μC) 106 with static data, e.g., the battery 108 died on the last transaction and was unable to write the special code after the window time period expired.

The crypto-table 105 can be used to store a set of crypto-text values that have been cryptographically pre-computed by a card manufacture 132 and preloaded into a look-up table. The values are sequenced by the on-board microcontroller when the card 102 is swiped by a merchant 114. These table values are such that a next valid value cannot be predicted from a presently valid value being used in a current transaction. The whole table of values is only valid for the particular card they are carried in, and compromising them will not assist a hacker in breaching any other card or account. The key used to generate the table is retained by the issuer and/or personalization bureau, and it is not retained on the microcontroller 106 or embedded within the crypto-table 105. An on-board crypto-engine would not have this particular advantage, but may be superior to a simple crypto-table in some applications. However, the security of all cards within the issuer customer base will be greater than a contact/contact/contactless security chip simply because the key is not retained within such controllers.

The QChip microcontroller 106 is awakened, e.g., by a swipe sensor, when the card is to be used. A next crypto-table value is accessed when needed. Swiping triggers the sending of a result to the QChip MEMS magnetic device 118 in data track 110. The QChip MEMS magnetic device 118 appears, e.g., to a legacy magnetic stripe card reader 118 as the discretionary track data in Track-2, Track-1, and/or a portion of the whole magnetically recorded data fields on the relative tracks. The data provided by the QChip MEMS magnetic device 112 can be internally re-written for each transaction. The next crypto-table result can be written after a transaction window period, and stored permanently until the next transaction, whereupon a new crypto-table result will be written. In this scheme, there will be no delay between sensing the card swipe, and writing a new crypto-table result to the QChip.

“Hard” magnetic materials, e.g., with coercivities high enough to support the magnetic data persistence needed to retain the magnetic data after being pulse-written, are included in the QChip MEMS magnetic device 118. The card readers must be able to read the data long after the initial writing, thereby conserving battery power. This persistence differentiates the QChip from prior art descriptions. But if the coercivity of the hard magnetic materials is too high, then excessive currents in the writing coils will be needed to flip the magnetic bits. This higher currents, if feasible, can severely limit battery life, increase thermal damage to the QChip structures, oxidize materials, among other damage to the device and card. So a compromise is needed. Coercivities in the range of 50-600 Oe seem practical at this point in the development. Experimentation and practical experience in actual mass consumer use is needed to refine these parameters. Early experiments and prototypes indicate hard materials with 200-300 Oe is a promising range of compromise. Indeed, the ISO standard for financial transaction card magnetic media was 300 oersteds for 20-30 years, and only recently increased to minimize ambient and stray magnetic field damage to the magnetic media. In future, better batteries should allow higher value materials to be used, e.g., 3500 Oe, the present standard for magnetic media.

Card 102 does not have to execute an encryption process. The numbers can be stored in table 105 during manufacturing. These numbers can be encrypted using a seed associated with the user, or they may be chosen at random and then ordered. The essential idea is that the next valid number cannot be predicted from any numbers that were used before, due to encryption techniques standard to the industry that include DES, 3-DES, AES, and similar. The payment server 114 allows some mis-synchronization for what should be the next valid number, within a range of next valid numbers such as it already knows are associated with the particular card. This mis-synchronization may be due to temporal offsets associated with batch authorization requests arriving our out sequence real-time authorization requests.

The means to communicate information read from the data track 110 to a payment processor 122 preferably relies on presently deployed legacy magnetic stripe card readers 120 and automated teller machines (ATM's) 122 to forward magnetic stripe swipe data to payment processor 122 for authentication, authorization, and payment. Each request is scanned by an access request program 124. If acceptable so far, the payment request is forwarded to a fraud detection program 126. Acceptable crypto-table values that were created during card manufacturing 116 are computed in the fraud detection program 126 in real-time use as they are presented so they do not need to be stored by the payment processor 114. An alert can be issued if the value was presented before and used without incident. If no fraud is detected, and payment authority is verified, a payment authorization program 130 sends an authorization code to the legacy magnetic stripe card reader 118 or ATM 122.

An add-on program for the payment processor 122 is provided with its own list of crypto-table values that were loaded into each card during manufacture, and checks these against what it receives in payment requests. Alternatively, a seed vector and algorithm and last known value can be stored, with the payment processor deriving the next predicted number in real-time. The advantage of this schema is that large data tables do not need to be stored for each customer and card. The server limits each value to one use, and the location and time of each use are logged. The management of the valid-number window on the server can be set up such that unused numbers expire a fixed time after a later number is received. In some instances, the number may be authorized for multiple uses from known and trusted entities. These entities may include hotels that swipe the card once and charge a night's lodging each day, or with Amazon and PayPal to enable multiple purchases on a stored card number.

A timer can be included in the card in alternative embodiments of the present invention. Such timer is activated on a trigger event, and prevents any other dynamic numbers from being generated until a pre-determined time has elapsed. If the timer times-out, a next transaction number is skipped and a new count is reset. This prevents copies of magnetic data track 110 data from being accepted in a decision making process to authorize the transactions after a fixed period of time.

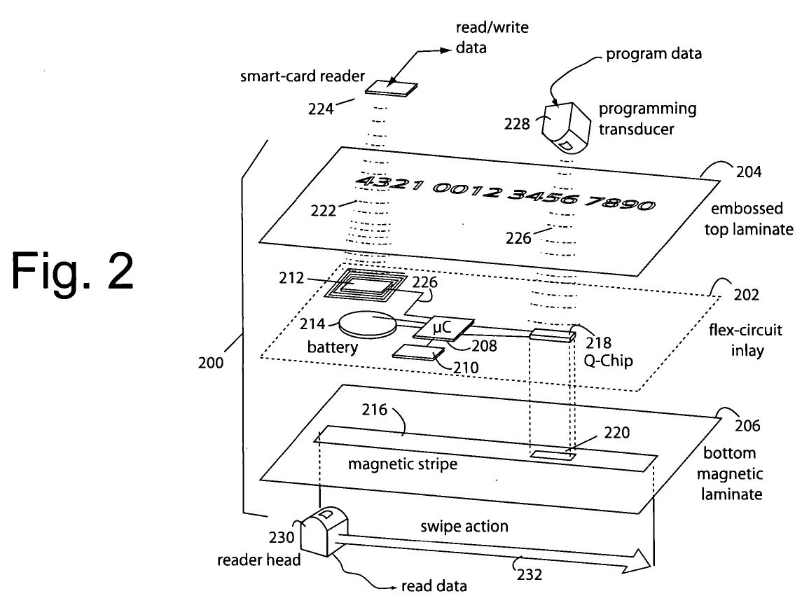

In FIG. 2, a credit card 200 is constructed with a flexible circuit inlay 202 sandwiched between two outer plastic laminates 204 and 206. It functions and appears to the user to be an ordinary credit card capable of both contact/contactless operation and usage in legacy magnetic card readers. A microcontroller (μC) 208, crypto-table memory 210, and contact/contactless processor 212 are powered, e.g., by a battery 214 and is electrically connected to the contact/contact/contactless chip 212. Alternatively, a photovoltaic cell, and/or piezoelectric strain generator can be used to provide operating power. Alternatively, an IR receiver or other communication interface generally defined early may substitute or augment the contact/contact/contactless smart chip. A magnetic stripe 216 includes discretionary data fields and the required account access information to be presented during a transaction. A QChip MEMS magnetic device 218 implements a programmable part 220, e.g., as in 112 of FIG. 1 and is installed planar to the card surface.

An electrical conductivity sensor is included within the QChip MEMS device 218 to detect when the card 200 is being swiped in a legacy magnetic stripe card reader, and when the microcontroller 208 should be activated. The microcontroller 208 is activated only long enough to write the new magnetic data, and the persistence of the magnetic material is relied upon to keep this data presentable for a card reader. Alternatively, swipe sensors may be placed at the ends of the magnetic stripe 216, with electrical interconnect to the microcontroller 208

In alternative embodiments, the embossed account numbers in top laminate 204 are replaced by a numeric display which is activated by a finger press, e.g., on an included “Q-button”. In such a transaction, the magnetic information on the card is not used. Instead, the card number, expiration date and the card validation/verification value (CVV2) are read off, or entered into online forms, by the user to complete a transaction. Contact/contactless operation, e.g., according to ISO and industry Specification, is conventionally supported by a wireless carrier signal 222 and a merchant's contact/contactless reader 224. Such supports an exchange of coupons, micropayment authorizations, transaction event reports, etc. A link 226 provides for communication between the magnetic receiver element of QChip 218 and the contact/contactless programming transducer 212 of the personalization bureau for purposes of entering crypto-table and other programming data during card manufacturing and personalization.

Payment card 200 resembles a typical payment or bank/ATM card, and conforms to ISO 7810 and other relevant form-factor standards. The payment card industry has published standards (such as ISO/IEC-7810, ISO/IEC-7811(−1:6), and ISO/IEC-7813, available from American National Standards Institute NYC, N.Y.), for all aspects of payment cards, and these regulate the card size, thickness, tolerance to flexing, positioning of account numbers and user information, magnetic recording formats on the magnetic stripe on the back, etc. Payment card 200 is compatible with these and contact/contactless industry standards so as to allow rapid assimilation into the payment card system and its use by consumers.

Payment card 200 comprises three pre-lamination layers 202, 204, and 206, which are fused together via a standard injection molding process typically referred to as LIM/RIM, or Liquid Injection Molding, Reaction Injection Molding. Other construction methods can be used, e.g., a solid cast material in which the electronics are embedded. The front, top layer 204 may include a digital user display for displaying a virtual personal account number (PAN). Some of the digits can be fixed and simply embossed and not electronically displayed. An alternative digital user display may be used to display a CVV2 or CVV3 number result. The middle layer 214 includes electronics for a virtual account number generator 208, a display controller, and a magnetic strip programmer 220. The back layer 216 has a partially programmable magnetic stripe 216 and may have a printed card verification value (CVV2).

In order to personalize each card with user-specific data that may include the crypto-table, algorithm, unique keys, or similar after the basic hardware manufacturing is completed, there must some means to insert customized cryptographic information into each card in a post-manufacturing step. Very small needle probes could be inserted at the edge of the card to make contact/contactless with pads on a flex circuit to program the card. Or, these programming pads could be made electrically accessible from somewhere on the surface of the QChip magnetic device. Another method comprises fixed electrical pads presented on the card surface, or via redundant contacts within the contact/contactless chip package.

Referring again to FIG. 2, an inductive or wireless coupling communication channel 226 generated by a programming transducer 228 is provided through the QChip MEMS magnetic device 218 back into the associated microcontroller (μC) 208. In normal operation, a legacy magnetic stripe card reader read head 230 is swiped 232 along the magnetic stripe 216 to collect the recorded card data. During the initial card personalization, a special program head with a strong field strength is placed nearby to transmit a pulse and stream of data over an inductive or wireless interface 226. The QChip MEMS magnetic device 218 senses the programming mode, and allows the program head 228 to stream personalization data through the interface to appropriate memory locations in the card electronics, e.g., pC 208 via the QChip 218. Once the programming and verification are completed, the interface 226 can be disabled so that this channel could not be used again. Alternative embodiments include maintaining this channel for use with Near Field Communication or similar wireless communications.

The programmable magnetic stripe will typically have two tracks of data programming written on such by a magnetic card writer, e.g., by a card issuer. Parts of the magnetic stripe are subject to being reprogrammed from within the payment card itself. Such is advantageous if these parts comprise relatively low-coercivity magnetic materials chosen to enable recording by the QChip 218. After the recordings have been used, the card can be used again, but only after a new account number is generated internally. The new account numbers will be unique to each transaction and merchant, so fraud detection is made possible at the issuing banks' payment processing servers.

The basic QChip MEMS magnetic device 218 generally comprises several thin-film coils of wire wrapped end-to-end and encompassing a common, flat, magnetic, possibly ferrous, core. These coils are individually driven by the microcontroller and shift-register. In one instance, such core includes a so-called “hard” magnetic material with a coercivity of 50-600 Oe. The hard magnetic material will serve as the magnetic medium where magnetic data resides.

If the core is made of a “soft” saturable magnetic material with a coercivity of about one Oersted, and a separate media stripe of “hard” magnetic film material overlays respective coils to receive magnetic data transfers from the coils and soft core, then such configuration is referred to herein as a soft magnetic core with hard medium, or simply “soft core”.

Magnetic data will persist for a long time in the overlaying hard media. A legacy magnetic stripe card reader could read these recorded data months later, although it may be advantageous to extend or shortened this time for specific applications.

In a data input mode, the thin-film coils with multiple taps can be used as readers to provide updates and new programming to the microcontroller. In this instance, the coil can receive information from specialized interface hardware that induces a changing magnetic field in the core, with such information then being converted to an electronic signal in the coil(s). This signal is then wave-shaped by the electromagnetic circuitry of the QChip and transferred to the microcontroller for digital interpretation and storage. Such a link can be used in manufacturing for programming the microcontroller, and may also be used in a payment environment for firmware updates, etc.

The implementation of payment card 200 is challenging in that all the electronics need to be very thin and low power. The digital displays must be flexible, and any embedded battery needs to be able to operate the electronics for at least two years of typical use. Conventional, albeit advanced technologies are presently available to fabricate payment card 200 as described. Therefore, a detailed description of those fabrication methods is not necessary here.

Some of the digits of the virtual account number in any display may be fixed. Such fixed numbers can be embossed or printed and not electronically represented. Similarly, some of the data related to the virtual account number and encoded to the magnetic stripe may also be fixed. The fixed bits can be recorded externally by a card writer, while the rest are electronically programmable from within. The fixed bits can represent the card type, and the bank number, e.g., the first 4-5 numbers of the personal account number. There can be some security benefits realized by not writing or displaying the virtual account numbers until they are actually going to be used.

In the past, the magnetic recordings laid down in the two or three tracks had some latitude in their exact placement on the magnetic stripe. However, payment card 200 will require that these recordings be properly aligned with the data being represented by the magnetic QChip MEMS magnetic device 218 that sits within the magnetic stripe 220. The mesh of the two magnetic data must be accurate to within one recorded sub-interval, or else guard bit positions must be provided to accommodate slight misalignments. A specialized card writer is also required for this purpose that can read and store the original recordings, sense the location of the magnetic QChip MEMS magnetic device 218, and write the recordings back in their properly aligned positions.

A magnetic array is arranged on the back of the card 102 behind the magnetic stripe 110. This presents what appears to be an ordinary magnetic stripe encoded with appropriate bank and user information for a conventional magnetic card reader. Such readers are ubiquitous throughout the world at point-of-sale terminals, and therefore it is very important not to require any changes to these readers in order to accommodate the proper use of payment card 200.

An embedded power source is needed by payment card 200 that can last for the needed service life of a typical card, e.g., about eighteen months to four years. A chemical or MEMS battery or a piezoelectric generator and charger can be used. Such a piezoelectric generator converts incidental temperature excursions and mechanical flexing of the card into electrical power that can charge a storage capacitor or help maintain the battery. A piezoelectric crystal is arranged to receive mechanical energy from card flexing, geo-magnetic induced stress, thermally-induced stress, mechanically-induced stress, and/or keypad use. The charger converts the alternating current (AC) received into direct current (DC) and steps such up to a voltage that will charge the battery. Alternative embodiments can include embedded photovoltaic cells to power the card or charge its battery.

A conventional, “legacy”, merchant point-of-sale magnetic-stripe card reader 118 is used to read user account data recorded on a magnetic stripe 216 on the payment card 200. Such is used by a merchant in a traditional way, the payment card 200 appears and functions like an ordinary debit, credit, loyalty, prepay, and similar cards with a magnetic stripe on the back.

User account data is recorded on the magnetic stripe 216 using industry-standard formats and encoding, for example, ISO/IEC-7810, ISO/IEC-7811(−1:6), and ISO/IEC-7813. These standards specify the physical characteristics of the cards, embossing, low-coercivity (e.g., 300-650 Oe) magnetic stripe media characteristics, location of embossed characters, location of data tracks 2-3, high-coercivity (e.g., 2500-4000 Oe) magnetic stripe media characteristics, and financial transaction cards. A typical Track-1, as defined by the International Air Transport Association (IATA), is seventy-nine alphanumeric characters recorded at 210-bits-per-inch (bpi) with 7-bit encoding. A typical Track-2, as defined by the American Bankers Association (ABA), is forty numeric characters at 75-bpi with 5-bit encoding, and Track-3 (ISO/IEC-4909) is typically one hundred and seven numeric characters at 210-bpi with 5-bit encoding. Each track has starting and ending sentinels, and a longitudinal redundancy check character (LRC). The Track-1 format includes user primary account information, user name, expiration date, service code, and discretionary data. These tracks conform to the ISO/IEC/IEC Standards 7810, 7811-1-6, and 7813, or other suitable formats.

The magnetic stripe 216 is located on the back surface of payment card 200. A data generator, e.g., implemented with microprocessor 208 and crypto-table 210, receives its initial programming and personalization data from a data receptor. For example, such data receptor can be implemented with the QChip coils themselves or a serial inductor placed under the magnetic stripe. This is then excited by a standard magnetic card writer. Additionally, the data may be installed at the card issuer, bank agency, or manufacturer by existing legacy methods. The data received is stored in non-volatile memory. Alternatively, a data receptor can be a radio frequency antenna and receiver, typical to ISO/IEC/IEC Specifications 14443 (a) (b) and 15693. Alternatively, the data receptor may be an IR device, or Near Field Communication (NFC) device. The data generator may be part of a secure processor that can do cryptographic processing, similar to Europay-Mastercard-Visa (EMV) cryptoprocessors used in prior art “smart cards”.

Card-swipes generate detection sensing signals from one or a pair of detectors. These may be implemented as top coats over QChip 218 and can sense ohmic contacts applied by magnetic read head 230 in a scan and transmit this change in resistivity to the microcontroller 208.

The legacy magnetic stripe card reader 118 and contact/contactless reader 224 are conventional commercial units as are already typically deployed throughout the world, but especially in the United States. Such deployment resistance in the world is deep and widespread The conversion of magnetic readers to contact/contactless and contact/contactless smartcard systems has been inhibited by merchant reluctance to absorb the costs, to question how many customers really need them, what employee training is needed, the counter space required, and other concerns. Card 200 can work with both systems and provide some of the advantages of the contact/contactless operation to the magnetic-only users.

An important aspect of the present invention is that the outward use of the payment card 200 does not require modifications of the behavior of the user, nor require any special types of card readers. However, some new software may need to be installed by the payment processors to support the appearance of coupons and micropayment authorizations in magnetic stripe supported transactions.

The magnetic-transducer in the QChip MEMS magnetic device 218 must be very thin and small, as they must fit within the relatively thin body of a plastic payment card, and be packed dense enough to conform to the standard recording bit densities in the respective tracks. Integrated combinations of micro-electro-mechanical (MEMS) systems, nanotechnology, and longitudinal and perpendicular ferromagnetics are therefore useful in implementations that use standard semiconductor and magnetic recording thin-film technologies. Reductions in size for the QChip MEMS magnetic device 218 can be achieved by increasing the bit density beyond present ISO standards, in which instance a transaction processor waiver for deviation may be requested. Advantages of size reduction include cost and ruggedability.

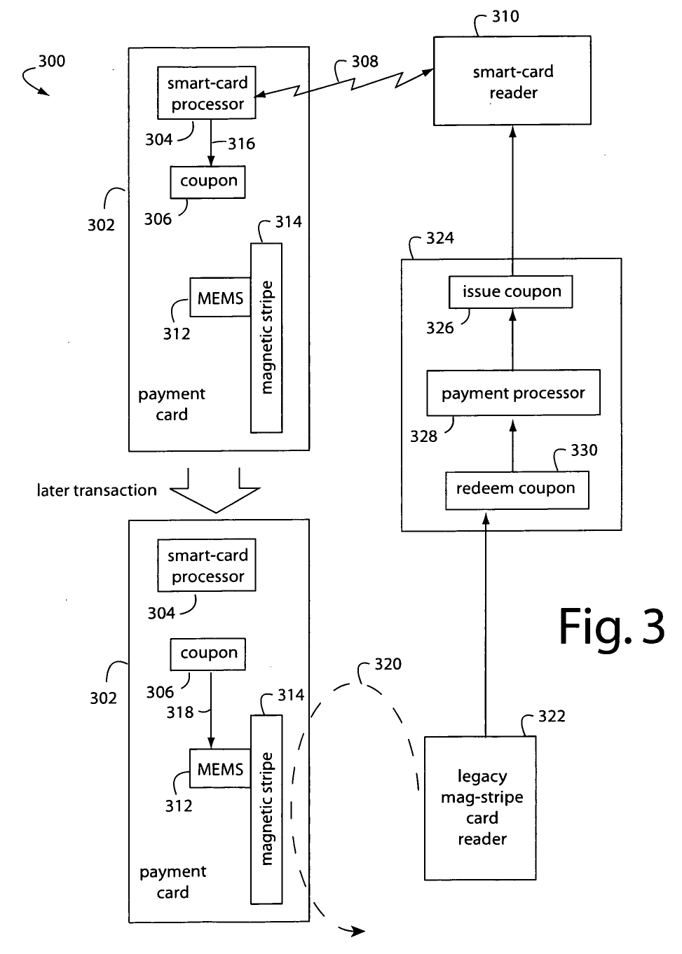

FIG. 3 represents a payment system 300 in which a payment card 302 is provided with a contact/contactless processor 304. It can receive a promotional coupon 306 over a near field wireless link 308 from a point-of-sale contact/contactless reader 310. The payment card further includes a QChip MEMS device 312 embedded in an otherwise typical magnetic stripe 314. A link 316 allows the coupon 306 to be passed during a first, contact/contactless commercial transaction to the QChip MEMS device 312 to appear in the magnetic stripe 314 as a flagged bit or sequence of bits. In a later, magnetic stripe supported transaction, another link 318 writes the coupon data for reading by a swipe 320 in a legacy magnetic stripe card reader 322.

A loyalty program administrator 324 includes an issue coupons process 326, a payments processor 328, and a redeem coupons process 330. As the user qualifies for rewards or is targeted for various promotions, the coupons are issued to be picked-up during the next contact/contactless transaction. The coupon 306 is thereafter present in card 302 to be available through either the contact/contactless or the magnetic-stripe infrastructures. If the card 302 includes a display, the coupon may be made visually available for online use.

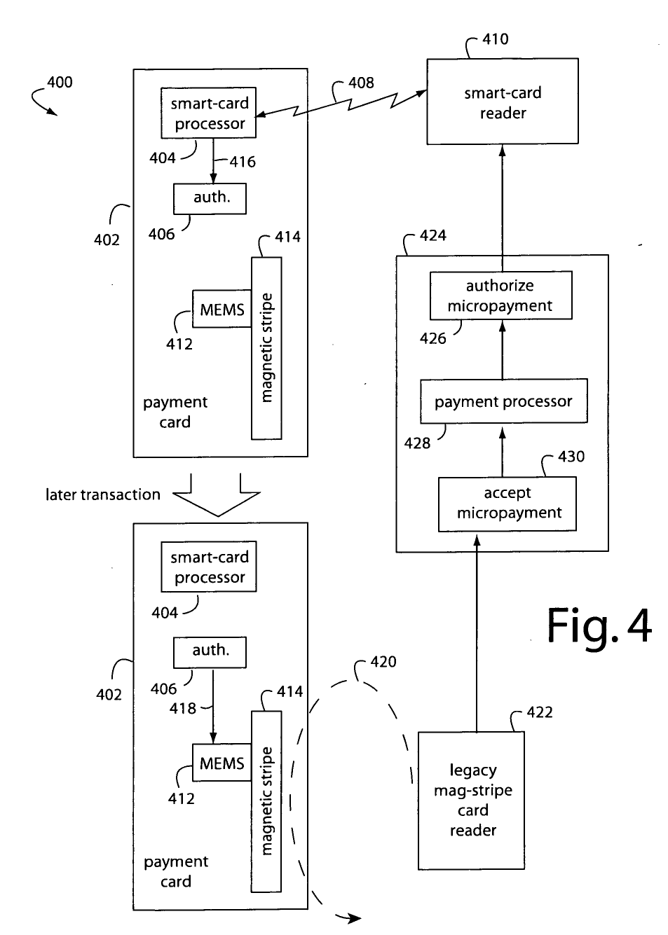

Nearly the same mechanisms can be used to allow micropayments on the magnetic stripe infrastructure side. FIG. 4 represents a micropayments system 400 in which a payment card 402 is provided with a contact/contactless processor 404. It can receive a micropayments authorization 406 over a near field wireless link 408 from a point-of-sale contact/contactless reader 410. The payment card further includes a QChip MEMS device 412 embedded in an otherwise typical magnetic stripe 414. A link 416 allows the micropayments authorization 406 to be passed during a first, contact/contactless commercial transaction to the QChip MEMS device 412 to appear in the magnetic stripe 414. In a later, magnetic stripe supported transaction, another link 418 writes the micropayments authorization data for reading by a swipe 420 in a legacy magnetic stripe card reader 422.

A payments server 424 includes an micropayments authorization process 426, a payments processor 428, and an micropayments acceptance process 430. Micropayment authorizations are issued to be picked-up during the next contact/contactless transaction. The micropayments authorization 406 is thereafter present in card 402 to be available through either the contact/contactless or the magnetic-stripe infrastructures. If the card 402 includes a display, the micropayments authorization may be made visually available for online use.

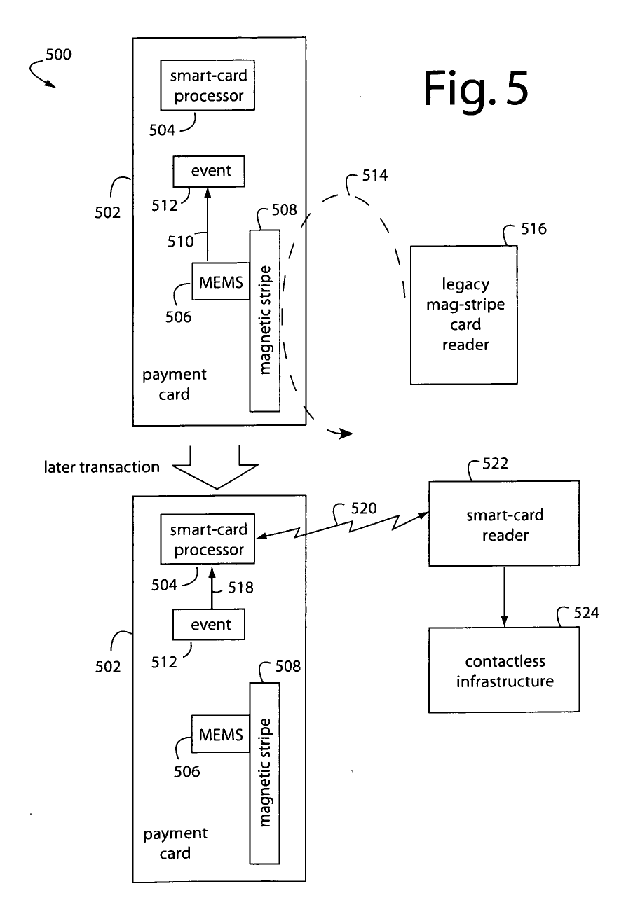

A reverse channel of sorts is available too. In FIG. 5, a loyalty program 500 includes a loyalty card 502 with a contact/contactless processor 504, a QChip MEMS device 506, and a magnetic stripe 508. A link 510 allows an event register 512 to be incremented, e.g., each time a swipe transaction 514 is recognized in connection with a partner's legacy magnetic stripe card reader 516. In a later transaction supported by a contact/contactless transaction, a link 518 provides the data from event register 512 to a contact/contactless-reader 522 and contact/contactless infrastructure 524 via the contact/contactless processor 504 and wireless connection 520. Such data can be used to accumulate “miles” or other measures that help a user earn “points” in a loyalty program, even when such was earned in a magnetic swiped transaction.

Alternative embodiments of the present invention allow the MEMS device to relay event counter or coupon information directly to other legacy magnetic stripe card readers 516.

In general, embodiments of the present invention can take a number of different forms and be used for purposes other than electronic payments. These include a payment system with a contact/contactless infrastructure for processing consumer payments related to merchant transactions. A magnetic-stripe infrastructure provides for processing consumer payments related to merchant transactions. A payment card included provides for consumer purchases. A contact/contactless processor is disposed within the payment card and supporting EMV-type exchanges. A magnetic stripe is disposed on the payment card and supports legacy magnetic stripe card reader use. A magnetic MEMS device is disposed in the magnetic stripe and provides for dynamic programming of some magnetic data written to the magnetic stripe. A link between the contact/contactless processor and the magnetic MEMS device inside the payment card provides for data communication between the contact/contactless infrastructure and the magnetic-stripe infrastructure that is related to a particular user's buying behavior with the payment card.

A coupon can be communicated from the contact/contactless infrastructure through the contact/contactless processor to the magnetic MEMS device over the link for presentation to the magnetic-stripe infrastructure from the magnetic stripe to enable the redemption of a loyalty reward. A micropayment authorization may also be communicated from the contact/contactless infrastructure through the contact/contactless processor to the magnetic MEMS device over the link for presentation to the magnetic-stripe infrastructure from the magnetic stripe to enable a micropayment transaction. A transaction event count would be useful if communicated from the magnetic stripe and the magnetic MEMS device over the link for presentation to the contact/contactless infrastructure through the contact/contactless processor to enable the generation of a loyalty reward.

A second magnetic stripe can associated with a corresponding second magnetic MEMS device. A gift card surrogate could then be communicated through the contact/contactless processor to the magnetic MEMS device over the link for presentation to the magnetic-stripe infrastructure from the second magnetic stripe to enable gift card transactions.

Similarly, a prepaid card surrogate can be communicated through the contact/contactless processor to the magnetic MEMS device over the link for presentation to the magnetic-stripe infrastructure from the magnetic stripe to enable gift card transactions.

For building and physical area security applications, an access card may be communicated through the contact/contactless processor to the magnetic MEMS device over the link for presentation to the magnetic-stripe infrastructure from the magnetic stripe to enable its use as a lock key. Or, a lock key is communicated from a contact/contactless interface through the contact/contactless processor to the second magnetic MEMS device over the link for interaction with the magnetic-stripe infrastructure via the second magnetic stripe to enable its use as an access card.

Broadly, a payment card has a contact/contactless processor disposed within to support EMV-type exchanges. A magnetic stripe is disposed on the payment card for supporting legacy magnetic stripe card reader use. A magnetic MEMS device is disposed in the magnetic stripe and provides for dynamic reprogramming of some magnetic data written to the magnetic stripe. There is a unique link, between the contact/contactless processor and the magnetic MEMS device inside the payment card, which provides for data communication between a contact/contactless infrastructure and a magnetic-stripe infrastructure that is related to a particular user's buying behavior with the payment card.

If a battery is disposed in the payment card to provide operational power for the contact/contactless processor and the magnetic MEMS device, then it would be helpful to also include a device for writing a magnetic data code to the magnetic stripe that can indicate the health of the battery to the magnetic-stripe infrastructure which would evoke a corrective action. FIG. 1 shows the components necessary to do this.

The payment cards can include micropayment authorizations and/or coupons communicated from the contact/contactless infrastructure through the contact/contactless processor to the magnetic MEMS device over the link for presentation to the magnetic-stripe infrastructure from the magnetic stripe to enable a small transaction, or for the redemption of a loyalty reward. A transaction event count maybe communicated in reverse from the magnetic stripe and the magnetic MEMS device over the link for presentation to the contact/contactless infrastructure through the contact/contactless processor to enable the generation of a loyalty reward. The internal link on the payment card is the critical connection between a contact/contactless processor and a MEMS magnetic device that can communicate information received from a contact/contactless payments infrastructure to be presented to a magnetic stripe payments infrastructure as specially recorded data bits written by the MEMS magnetic device in a magnetic stripe track.

In alternative embodiments, a dual use is enabled when a second magnetic stripe with a magnetic MEMS device is disposed on the payment card that is also readable by a magnetic stripe card reader. The second magnetic stripe can support magnetic data recordings for a distinct second use that would otherwise be incompatible with a primary use of the card if recorded on the first magnetic stripe.

Although particular embodiments of the present invention have been described and illustrated, such is not intended to limit the invention. Modifications and changes will no doubt become apparent to those skilled in the art, and such is intended that the invention only be limited by the scope of the appended claims.

The invention claimed is:

1. A payment system, comprising:
a contact/contactless infrastructure for processing consumer payments related to merchant transactions;
a magnetic-stripe infrastructure for processing consumer payments related to merchant transactions;
a payment card providing for consumer purchases;
a contact/contactless processor disposed within the payment card and supporting EMV-type exchanges;
a magnetic stripe disposed on the payment card and supporting legacy magnetic stripe card reader use;
a magnetic MEMS device disposed in the magnetic stripe and providing for dynamic programming of some magnetic data written to the magnetic stripe; and
a link between the contact/contactless processor and the magnetic MEMS device inside the payment card, and providing for data communication between the contact/contactless infrastructure and the magnetic-stripe infrastructure that is related to a particular user's buying behavior with the payment card.

2. The payment system of claim 1, further comprising:
a coupon communicated from the contact/contactless infrastructure through the contact/contactless processor to the magnetic MEMS device over the link for presentation to the magnetic-stripe infrastructure from the magnetic stripe to enable the redemption of a loyalty reward.

3. The payment system of claim 1, further comprising:
a micropayment authorization communicated from the contact/contactless infrastructure through the contact/contactless processor to the magnetic MEMS device over the link for presentation to the magnetic-stripe infrastructure from the magnetic stripe to enable a micropayment transaction.

4. The payment system of claim 1, further comprising:
a transaction event count communicated from the magnetic stripe and the magnetic MEMS device over the link for presentation to the contact/contactless infrastructure through the contact/contactless processor to enable the generation of a loyalty reward.

5. The payment system of claim 1, further comprising:
a second magnetic stripe associated with a corresponding second magnetic MEMS device;
a gift card surrogate communicated through the contact/contactless processor to the magnetic MEMS device over the link for presentation to the magnetic-stripe infrastructure from the second magnetic stripe to enable gift card transactions.

6. The payment system of claim 1, further comprising:
a prepaid card surrogate communicated through the contact/contactless processor to the magnetic MEMS device over the link for presentation to the magnetic-stripe infrastructure from the magnetic stripe to enable gift card transactions.

7. The payment system of claim 1, further comprising:
a second magnetic stripe associated with a corresponding second magnetic MEMS device;
a prepaid card that can be communicated from the contact/contactless interface through the contact/contactless processor to the second magnetic MEMS device over the link for presentation to the magnetic-stripe infrastructure from the second magnetic stripe to enable a gift card transaction.

8. The payment system of claim 1, further comprising:
an access card communicated through the contact/contactless processor to the magnetic MEMS device over the link for presentation to the magnetic-stripe infrastructure from the magnetic stripe to enable its use as a lock key.

9. The payment system of claim 1, further comprising:
a second magnetic stripe associated with a corresponding second magnetic MEMS device;
a lock key communicated from a contact/contactless interface through the contact/contactless processor to the second magnetic MEMS device over the link for interaction with the magnetic-stripe infrastructure via the second magnetic stripe to enable its use as an access card.

10. A payment card, comprising:
a contact/contactless processor disposed within a payment card for supporting EMV-type exchanges;
a magnetic stripe disposed on the payment card for supporting legacy magnetic stripe card reader use;
a magnetic MEMS device disposed in the magnetic stripe and providing for dynamic reprogramming of some magnetic data written to the magnetic stripe; and
a link between the contact/contactless processor and the magnetic MEMS device inside the payment card, and providing for data communication between a contact/contactless infrastructure and a magnetic-stripe infrastructure that is related to a particular user's buying behavior with the payment card.

11. The payment card of claim 10, further comprising:
a battery disposed in the payment card and providing operational power for the contact/contactless processor and the magnetic MEMS device; and
means for writing a magnetic data code to the magnetic stripe that can indicate the health of the battery to said magnetic-stripe infrastructure and evoke a corrective action.

12. The payment card of claim 11, further comprising:
a coupon communicated from the contact/contactless infrastructure through the contact/contactless processor to the magnetic MEMS device over the link for presentation to the magnetic-stripe infrastructure from the magnetic stripe to enable the redemption of a loyalty reward.

13. The payment card of claim 11, further comprising:
a micropayment authorization communicated from the contact/contactless infrastructure through the contact/contactless processor to the magnetic MEMS device over the link for presentation to the magnetic-stripe infrastructure from the magnetic stripe to enable a micropayment transaction.

14. The payment card of claim 11, further comprising:
a transaction event count communicated from the magnetic stripe and the magnetic MEMS device over the link for presentation to the contact/contactless infrastructure through the contact/contactless processor to enable the generation of a loyalty reward.

15. A method of providing a magnetic-stripe type payment card with coupons and micropayment authorizations, comprising:
providing an internal link on a payment card between a contact/contactless processor and a MEMS magnetic device that can communicate information received from a contact/contactless payments infrastructure to be presented to a magnetic stripe payments infrastructure as specially recorded data bits written by the MEMS magnetic device in a magnetic stripe track.

16. A system, comprising:
a contact/contactless smart card infrastructure for processing consumer payments related to merchant transactions;
a magnetic-stripe infrastructure for processing consumer or business payments related to merchants transactions;
a payment card providing for consumer and business purchase transaction payments;
a smart card processor disposed within the payment card and supporting at least one of BO′ and EMV-type exchanges;
a first magnetic stripe disposed on the payment card and supporting the use of a legacy magnetic stripe card reader;
a magnetic MEMS device disposed in the first magnetic stripe and providing for dynamic programming of a least a portion of a magnetic data written to the first magnetic stripe; and
a link between the smart card processor and the magnetic MEMS device inside the payment card, and providing for data communication between the contact/contactless infrastructure and the magnetic-stripe infrastructure.

17. The system of claim 16, further comprising:
a gift card surrogate communicated to the magnetic MEMS device over the link for interaction with the magnetic-stripe infrastructure via the first magnetic stripe which enables its commercial use of as a gift card.

18. The system of claim 16, further comprising:
a gift card surrogate communicated from a contact/contactless interface through the contact/contactless processor to the magnetic MEMS device over the link for presentation to the magnetic-stripe infrastructure from the first magnetic stripe to enable its use.

19. The system of claim 16, further comprising:
a second magnetic stripe associated with a corresponding second magnetic MEMS device;
a gift card electronic equivalent communicated through a smart card interface to the magnetic MEMS device over the link for presentation to the magnetic-stripe infrastructure from the second magnetic stripe to enable its use as a gift card.

20. The system of claim 16, further comprising:
a prepaid gift card electronic equivalent communicated through a smart card interface to the magnetic MEMS device over the link for presentation to the magnetic-stripe infrastructure from the first magnetic stripe.

21. The system of claim 16, further comprising:
a second magnetic stripe with recorded track data that can be modified by a magnetic MEMS device;
a prepaid card surrogate communicable to the magnetic MEMS device over the link for reading by the magnetic-stripe infrastructure from the second magnetic stripe.

22. The system of claim 16, further comprising:
an access card code communicable to the magnetic MEMS device over the link for presentation to the first magnetic stripe to enable its use as a lock key.

23. The system of claim 16, further comprising:
a second magnetic stripe with recorded track data that can be modified by a magnetic MEMS device;
an access card code communicable to the magnetic MEMS device over the link for presentation to the second magnetic stripe to enable its use as a lock key.

24. The system of claim 16, further comprising:
a second magnetic stripe with a magnetic MEMS device disposed on the payment card and readable by a magnetic stripe card reader;
wherein, the second magnetic stripe supports magnetic data recordings for a distinct second use that would otherwise be incompatible with a primary use of the card if recorded on the first magnetic stripe.
